(19) United States
(12) Patent Application Publication
(10) Pub. No.: US 2002/0004543 A1
(43) Pub. Date: Jan. 10, 2002

(54) Damping in composite materials through domain wall motion

(76) Inventors: Greg P. Carman, Los Angeles, CA (US); Geoff McKnight, Los Angeles, CA (US)

Correspondence Address: KENYON & KENYON, ONE BROADWAY, NEW YORK, NY, 10004, US

(21) Appl. No.: 09/844,409

(22) Filed: Apr. 27, 2001

Related U.S. Application Data
(60) Provisional application No. 60/200,606, filed on Apr. 28, 2000.

(51) Int. Cl. B32B 31/00; H05B 6/00; C08L 1/00; C08J 3/00; C08K 3/10

(52) U.S. Cl. 524/408; 156/272.4; 264/429; 524/413

(57) ABSTRACT

The present invention relates to composite materials exhibiting passive domain-wall activated damping, methods for using passive domain-wall activated damping, and processes for producing materials that exhibit passive domain-wall activated damping. One typical embodiment uses a polymer matrix phase and a dispersed particulate phase that exhibits domain wall motion under an applied mechanical load. Materials that exhibit domain wall motion under an applied mechanical load include magnetostrictive, piezoelectric and electrostrictive materials. One specific embodiment used Terfenol-D as the damping phase, aligned by magnetization during curing in a polymer matrix. Other specific embodiments employed PZT-5H and PMN-PT as the damping phase.

### FIELD OF THE INVENTION

The present invention relates to composite materials exhibiting passive domain-wall activated damping, methods for using passive domain-wall activated composites, and processes for producing passive domain-wall activated composites.

### BACKGROUND OF THE INVENTION

Applications for materials, which damp acoustic waves, range from vibrational damping in aerospace applications to tuning of sound recording studios for improved sound recording fidelity. Acoustical damping can be classified as either passive or active. Passive damping has been limited to viscoelastic damping in the past, which merely absorbs energy in proportion to the sound velocity in the material. Therefore, viscoelastic damping materials have properties which vary appreciably with frequency of the acoustic waves and the velocity of sound in the material, which is temperature dependent. This makes the use of these damping materials impractical over a wide range of frequencies and temperatures.

Active damping techniques employ a sensor/actuator combination either with or without external feedback processing. These systems are not necessarily frequency dependent, but active damping relies on the interaction of the sensor, actuator and control systems. Therefore, active damping systems are generally significantly more complex and more prone to failure that passive damping systems, increase the overall expense of systems employing active damping.

Structurally stiff materials are not suitable for damping, and viscoelastic materials are not suitable for structural applications. [M. Brodt and R. S. Lakes, Journal of Composite Materials, 14:1823-1833 (1995)]. Viscoelastic materials (VEMs) have limited stiffness and reduced thermal operating ranges, as well as being frequency dependent.

These limitations are inherent to VEMs, because the molecular bonding that causes damping by producing a hysteresis does not provide for a material with adequate stiffness to weight for structural applications. Viscoelastic damping materials creep in the presence of quasi-static loads.

A new class of materials, passive domain-wall activated composite (“PADWAC”), offers several distinct advantages when compared to VEMs. Passive components in the composite absorb mechanical energy (i.e. have stress-strain hysteresis) through a magnetic, or electric domain level mechanism rather than through molecular chain interactions. These materials have relatively high stiffness as compared to VEMs, high-energy absorption, and can be used over relatively broad temperature ranges, including cryogenic temperatures where VEM's exhibit low damping properties. A specific example of a PAD-WAC is the magnetostrictive particle composite. Magnetostrictive composites have been investigated previously for use as actuators, but their passive damping properties have been limited to theory.

Hathaway et al. first discussed the passive damping properties of magnetostrictive materials (e.g. Terfenol-D) in 1996 [J. P. Teter, K. B. Hathaway, A. E. Clark, Journal of Applied Physics, Vol. 79 B: 6213-6215 (1996); and K. B. Hathaway, A. E. Clark, J. P. Teter, Metallurgical and Materials Transactions A, Vol. 26A:2797-2801 (1995)]. The Teter et al. authors described domain level motion as a fundamental energy absorption mechanism in a magnetostrictive material under mechanical loading. Teter et al. predicted that the amount of energy absorption would dependon the magnitude of the stress applied to a magnetostrictive material, and would be relatively independent of frequency. Teter et al. theorized that the reason for this behavior would be related to the finite number of stable magnetic configurations within the crystal structure of a magnetostrictive material. An application of mechanical load along one plane of the crystal structure of a magnetostrictive material would lower the energy barrier for realignment of the magnetic domains within the material. At a critical stress level, the magnetization could then “jump” from one stable orientation to another stable orientation, in a non-reversible, energy-absorbing process.

Hathaway et al. describe the energy-absorption process associated with domain level motion as fundamentally different than magnetic hysteresis, which is the process of domain wall pinning and subsequent irreversible migration though the crystal [K. B. Hathaway, A. E. Clark, J. P. Teter, Metallurgical and Materials Transactions A, Vol. 26A:2797-2801 (1995)]. Also, the application of mechanical stress to a magnetostrictive material does not influence the 180° domain walls. This is in contrast to magnetic field induced hysteresis where the 180° domain walls account for a large portion of the magnetic energy absorbed.

In addition to analysis, Hathaway et al. conducted some experimental work on a homogeneous, also referred to as monolithic, Terfenol-D specimens [Hathaway, et al., supra]. The chemical composition of Terfenol-D was described as Tb_{[0.27-0.30]}DY_{[0.73-0.70]}Fe_{[1.90-1.95]}. The experiments consisted of applying a saturating electromagnetic field to the specimen, releasing the field, and then applying a mechanical load. The saturating field was applied to rotate the magnetic domains predominantly parallel to the loading direction. Results of Hathaway et al. [3] indicate that the material exhibits a large single cycle damping behavior characterized by a maximum Q factor of 0.28 at a stress amplitude of 5 MPa. However, the single cycle damping limitation significantly reduces the usefulness of the material as a damper. We believe that a composite sample could be used to overcome this limitation. In a composite, the domains could be aligned with a tensile load eliminating the need for an external electromagnetic field.

U.S. Pat. No. 5,792,284 to Cedell and Sandlund discloses one magnetostrictive powder composite and a method for producing it that includes using a magnetic field to align the domains, but the disclosure is specifically limited to magnetostrictive powder greater than 60% by volume, and is used for actively generating acoustic vibrations using a magnetic field to cause the magnetostrictive material to expand and contract.

U.S. Pat. No. 4,378,258 to Clark et al. discloses the production of magnetostrictive power in a resin matrix with up to 60% magnetostrictive powder, but the emphasis on active applications for converting magnetic energy to mechanical energy causes Clark et al. to teach away from anisotropic composites for use in passive damping applications; therefore, there is no suggestion to use an electromagnetic field to align the particles in the resin matrix composite.

Work on polymer matrix magnetostrictive composites has focused on improving the high frequency performance of Terfenol-D transducers by eliminating eddy currents losses [L. Sandlund, M. Fahlander, T. Cedell, A. E. Clark, J. B. Restorff, M. Wun-Fogle, Journal of Applied Physics, Vol. 75: 5656-5658 (1994); T. A. Duenas and G. P. Carman, 1998 ASME, Anaheim, Calif., AD Vol. 57, MD 83: 63-73 (1998); and J. H. Goldie, M. J. Gerver, J. Olesky, G. P. Carman, T. A. Duenas, 1999 SPIE, Newport Beach, Calif., 3675: 23235 (1999)]. Researchers report results with frequency performances in excess of 10 kHz [Goldie, et al., supra], representing an order of magnitude improvement over the monolithic Terfenol-D. In addition to enhanced bandwidth, the composite is also significantly more durable than the monolithic, permitting complex mechanical loads such as tension, shear, and impact loading to be supported, rather than simple compression, as is the case for the monolithic. These and other properties support the proposition that magnetostrictive composites could be used in damping applications where the loading is generally a complex state of bending or shear. An additional advantage of composite materials for damping applications is that the stiffness of the composite can be tailored by changing the volume fraction of the constituent materials [Duenas, et al., supra]. Thus, one can impedance match the material for a specific application to maximize energy transfer into the damping material.

### BRIEF SUMMARY OF THE INVENTION

A goal of the present invention is to provide a composite system for passively damping acoustic vibrations or waves. The present invention achieves passive vibrational damping by energy-absorbing domain wall motion under the mechanical load associated with the vibration. It has been shown that domain alignment can been achieved by applying a tensile mechanical load to the composite. The matrix phase transfers the load to the magnetostrictive phase, and at a critical stress the domains realign in response to the applied tensile load. The monolithic form of Terfenol-D and other pure mangetostrictive materials are brittle and fracture easily under tensile loading. Therefore, it would not be possible to achieve domain realignment in monolithic, brittle magneto strictive materials, and they would not be suitable for passive damping applications.

The present invention allows a tensile load to be applied to the magnetostrictive materials through the matrix material. Subsequent compressive loading by the acoustic wave realigns the domains again, when the critical load for domain realignment is exceeded. The aligning and realigning by tensile and compressive forces on the crystalline structure is irreversible, meaning that it is associated with an energy loss, which causes damping of the vibrational waves. This allows the internal magnetic domain structure to be reset each loading cycle and permits the composite behavior under only mechanical loading to emulate the monolithic material under a combination of magnetic and mechanical loading.

Another goal of the present invention is to engineer impedance matched systems. The level of damping in the composites can be controlled through both the volume fraction of active material as well as the alignment of the particles within the composite. This alignment can be introduced during the composite manufacturing and is unique to the composite material approach. Thus, specific compositions can be tailored for specific applications to provide optimal damping.

In one preferred embodiment of the present invention, the percent of material exhibiting domain wall motion under mechanical load (the “Damping Phase”) is less than or equal to about 60% of the total volume of the substantially solid composite. The remainder of the solid composite was comprised of a non-active matrix phase (the “Matrix Phase”), which transferred the mechanical load associated with vibration to the Damping Phase, which passively damped the vibration. At a volume percent greater than about 60%, the solid composite began to lose structural integrity. The inventor's believe that the vibrational loading undermined the matrix phase and the structural integrity of the solid composite, when the volume percent of Matrix Phase was less than about 35%. However, depending on the material chosen for the Matrix Phase, the inventors believe that the Matrix Phase could be reduced below about 35%; however, they believe that this would limit the lifetime of the composite or the maximum permissible amplitude for the vibrational load. More preferably, the volume percent of Damping Phase is between about 10% and about 50% with the substantially all of the remaining volume occupied by Matrix Phase. More preferably still, the volume percent of Damping Phase was selected to be about 20% Damping Phase.

Suitable Matrix Phase materials include polymer and non-polymer materials, which maintain structural integrity of the composite during tensile and compressive loading, provide sufficient structural stiffness and strength for a particular application, achieve long term stability at operating temperatures in the presence of the Damping Phase, and efficiently transfer the vibrational loads to the Damping Phase. Materials for the Damping Phase include any magnetostrictive, piezoelectric, or electrostrictive that exhibits domain wall motion under mechanical load. Preferred Damping Phase materials are compatible with the Matrix Phase, display long term stability under expected vibrational loading conditions, and have a compatible critical stress level for activating domain wall motion under the expected vibrational loading conditions to be damped.

In another preferred embodiment of the present invention, the volume percent of material exhibiting domain wall motions was between about 10% and about 50%. More preferably, the volume percent was about 20%.

Yet another goal of the present invention is to provide a material that can respond to impulse loading or shock loading. Due to the wide frequency response of the composites of the present invention, they are ideal candidates for shock loading situations. In one embodiment, a composite with about 20% by volume of Damping Phase can be used in a shock loading environment. The Matrix Phase is both tough and stiff and efficiently transfers the load to the Damping Phase, which effectively damps the vibration caused by striking an object. In one preferred embodiment, the composite can be used in sports equipment. More specifically, the composite can be used in a racket, golf club, or ski.

In addition, the composite can be used in aerospace structures, including tanks, wings, spars and panels, and automotive bodies, components, and panels. All of these structures benefit from a material that can passively damp vibrations efficiently.

The present invention is directed to a composite material which incorporates magnetostrictive, piezoelectric, or electrostrictive materials. In one embodiment of a magnetostrictive material, Terfenol-D was used as the Damping Phase. In another embodiment, PZT-5H, a piezoelectric material, was used as the Damping Phase. In yet another embodiment of the invention PMN-PT, an electrostrictive material, could be used as the Damping Phase.

The inventors believe that the composite material must exhibit mechanical hysteresis resulting form the non-conservative motion of magnetic or electric domain structures within the material at the subgrain level. However, the invention is not restricted to this theory for the cause of the energy absorbing quality of magnetostrictive, piezoelectric and electrostrictive materials. Such materials, which the inventors describe as having domain wall motion under mechanical load, when incorporated into an appropriate matrix material have exhibited the ability to dampen vibrations passively, without an active control system.

The Damping Phase can be comprised of substantially spherical particles, elongated particle, fibers or any other morphology or combination of morphologies. The Damping Phase is mixed into the Matrix Phase, creating a mixture, which can be shaped into a desired part. Alternatively, the mixture can be sandwiched between sheets of composite preform. The sheet of composite preform can then be formed in the convention manner to form a composite panel. Pressure or heat or both pressure and heat can be used to set up the composite structure, and an electromagnetic field can be applied to align the Damping Phase in a desired direction. For example, it might be desirable to damp vibration in one direction in the composite panel or alternating layers could be built up by successive operations.

These and other features, aspects, and advantages of the present invention will become better understood with regard to the following detailed description and accompanying drawings.

### BRIEF DESCRIPTION OF THE DRAWINGS

FIG. 1 illustrates the experimental setup for tension-compression, and torsion loading of the specimen within the solenoid;

FIG. 2 illustrates the stiffness values that can be obtained by altering the volume fraction of particulate;

FIG. 3 is a graph plotting the typical raw stress-strain hysteresis for the array of specimens tested at similar maximum stress loadings;

FIG. 4 is a graph of the comparison loss tangent of magnetostrictive composites plotted against the maximum stres in the material. There was a general decreasing trend in energy absorption with increasing stress;

FIG. 5 is a graph showing the effect of an external bias field on the loss tangent for a 40% V_{f} Terfenol-D composite and

FIG. 6 is an illustration summarizing the influence of shear loading on the loss tangent of a 40% V_{f} Terfenol-D composite at different magnetic fields.

### DETAILED DESCRIPTION OF THE INVENTION

One embodiment of the present invention used a polymer Matrix Phase with a particulate magnetostrictive Damping Phase (“MDP”). A more specific embodiment of the invention used a MDP having the chemical composition given by TbₓDy₍₁₋ₓ₎Fe_{(2-w)}, with 0.2≦x≦1.0 and 0≦w≦0.5. In another embodiment the MDP had the chemical composition SmₓFe_{(2-w)}, with 0.2≦x≦1.0 and 0≦w≦0.5.

The present invention should be understood to include compositions having other impurities present in either the Matrix Phase or Damping Phase. Inclusion of such impurities, whenever a composition is specified, is considered within the scope of the present invention, and one of ordinary skill in the art would recognize that such impurities may have an impact on the efficiency of load transfer, and the critical stress required to achieve domain wall motion. Furthermore, inclusion of impurities can be either deliberate or unintentional and either improve or degrade performance of the composite and still fall within the scope of the present invention.

In another embodiment of the invention, a particulate piezoelectric Damping Phase (“PDP”) was used. In a specific embodiment, a PDP with a chemical composition of (Pb(ZrₓTi₍₁₋ₓ₎))O₃ was used, where 0<x<1, and the Matrix Phase was a polymer. A more specific embodiment used the composition generally referred to as PZT-5H, which had a composition within the range specified by the chemical composition (Pb(ZrₓTi₍₁₋ₓ₎))O₃ as previously specified.

In yet another embodiment of the invention, a particulate electrostrictive Damping Phase (“EDP”) could be used. In one specific embodiment, the chemical composition of the EDP is [Pb(MgₓNb₍₁₋ₓ₎)O₃]_{(1-w)}—[PbTiO₃]_{w}, also referred to as PMN-PT, where 0<x<1 and 0<w<1.

In each of the embodiments, the energy absorption mechanism in the active Damping Phases stemmed from coupling of domain wall movement under the applied cyclical tensive-compressive loads. The non-active Matrix Phase merely acted as a structural material and to transfer the load to the active Damping Phases. The composite comprised the Damping Phase dispersed within the Matrix Phase. By dispersed, the inventors mean that the Damping Phase is substantially surrounded by Matrix Phase; however, aggregating or clustering of Damping Phase can often cause particles of the Damping Phase to be in contact with each other, especially as the volume percent of Damping Phase approaches 60%. Indeed, it is desirable to have the particles aligned by application of a strong electromagnetic field during curing of the Matrix Phase. This allows an anisotropic composite to be formed with improved damping properties in a specified direction, and the application of the electromagnetic field causes particles to be in contact along the lines of magnetic flux. Nevertheless, the Matrix Phase helped to provide structural integrity and to transfer the load to the Damping Phase, whether the Damping Phase was particulate or some other morphology, and having particles in contact is specifically included within the scope of the present invention.

The mechanical energy absorption characteristics of several polymer matrix Terfenol-D composites were evaluated. The magnetic domains proved to be strongly coupled with the mechanical field, and the mechanical loading changed the magnetic domain structure within the material, causing damping of the applied load. The effectiveness of the damping was determined by mechanically cycling the materials at various stress amplitudes (combined compression and tension as well as torsion) at a single frequency. Results indicated that the magnetostrictive composites exhibited both efficient damping and a stiffness much greater than that associated with viscoelastic materials. The measured “tan delta” values for the materials were a function of the stress amplitude and peak at 0.25 for the specimens measured in this study.

In general, as the stress amplitude increased, the damping or energy absorbed during one cycle decreased. Results also indicate that damping is directionally dependent (anisotropic) and that an electromagnetic field applied as a bias decreased the energy absorption. It is likely that the particulate Damping Phase was pre-loaded by the Matrix Phase during curing. Results indicate that the volume fraction of Damping Phase in the composites did not play a significant role in the magnitude of damping. This effect may be related to the inherent pre-loading of the particulate Damping Phase by the resin during cure, and the values reported in the results should not be viewed as maximum damping values inherent to the material. The pre-loading could be reduced by proper selection of the Matrix Phase or by subsequent curing of the composite to relieve the stresses imparted by the Matrix Phase during curing.

Results

Specimen Preparation

In one embodiment, specimens were prepared using a low viscosity vinyl ester resin system that cures at room temperature and has a mix viscosity of 100 centipoise. The Terfenol-D magnetostrictive particles consisted of a poly-distribution mixture with all particles less than 300 microns in length. The particles were of varying shape due to the ball milling process used to create the particles from the bulk material. The particles and resin were mixed and repeatedly degassed to remove unwanted trapped air. The specimens were placed in a static magnetic field produced by two large rare earth permanent magnets, and the resin allowed to cure. The static magnetic field aligns the particles into chains and creates an anisotropic particle distribution. The aligned particles can be thought of as fibers, and displayed a composite connectivity of 1:3. In this embodiment of the invention, three specimens containing Damping Phase volume fractions of 20, 30, and 50 percent were produced with the particle aligned in the direction of loading (referred to as a 0 degree composite). One sample, with a Damping Phase volume fraction of 20% was produced with the particles aligned perpendicular to the direction of loading (referred to as a 90 degree composite) to examine the influence of particle alignment orientation on the damping properties. One resin sample was also manufactured without particles (0%) to determine the properties of the vinyl ester without reinforcement.

Tension and Compression Tests of Specimens

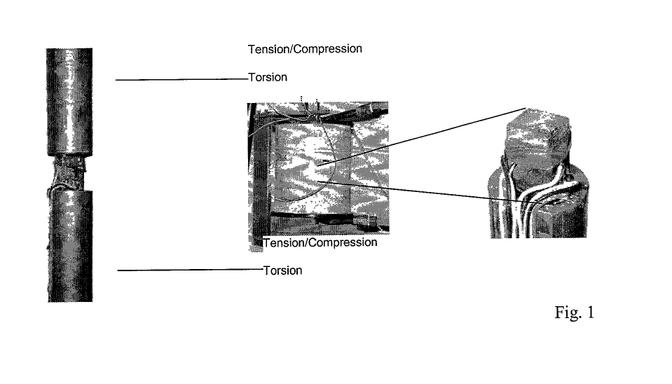

The specimens were tested in tension and compression using a hydraulic testing machine operated in load control mode. Each specimen was instrumented with two axial bi-directional strain gages and a flux pick-up coil (FIG. 1). The magnetic field was created using a water cooled solenoid. Steel pushrods were used to load the approximately 2.5×1×1 cm specimens within the solenoid. The specimens were mounted in a butt joint configuration that limited the tensile stress to less than 16 MPa (FIG. 1). This stress amplitude (i.e. 16 MPa) was considered to be sufficiently high to align a significant portion of the domains with the loading direction. The amplitude of the compressive stress was similar in absolute magnitude to the tensile stress for all tests. The precision of the load cell limited the smallest mechanical load range to be 2 MPa peak to peak. All testing was performed at a frequency of 1 Hz to reduce frequency effects from the results and minimize the damping contributions from the polymer resin. The main purpose of these tests was to investigate the energy absorption of the magnetostrictive composite caused by domain wall motion under the mechanical load.

Torsion Testing of Specimens

Since many damping applications use a constraint layer technique where the primary deformation of the damping material is in shear, it is important to evaluate the shear properties of the composites. If a pure torsion is applied to a cylindrical specimen and the axial direction remains tractionless, the cylinder only undergoes shear deformation. For these experiments, the specimens were machined into cylinders and then instrumented with +/−45° strain gages to obtain the shear strain. The samples were again mounted in a butt-joint configuration that permitted up to 16 MPa average shear stress amplitude loading. The samples were cycled loaded in torsion at various amplitudes at 1 Hz. The results were then used to obtain the shear stress versus shear strain plots where the energy absorption and tan delta could be obtained.

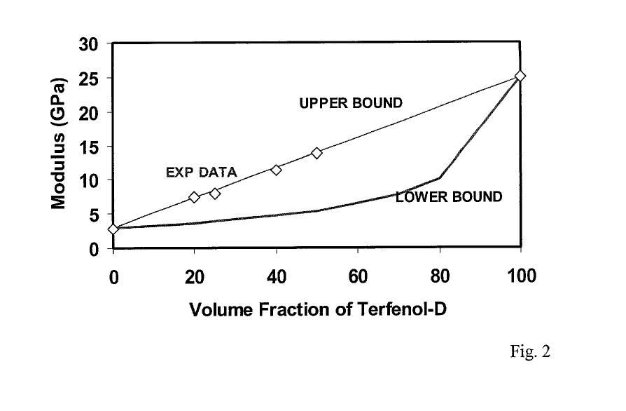

The results of the secant modulus measurement of the samples as a function of volume fraction are presented in FIG. 2. Secant tangent is defined in this paper as the slope between the unloaded specimen and the stress and strain at maximum stress loading (8 MPa in these results). As can be observed, the modulus is a linear function of volume fraction which indicates that the composite is of the 1-3 type and not the 0-3 type. This graph also demonstrates that the modulus can be varied as a function of volume fraction to meet application requirements, which is beneficial for a design engineer.

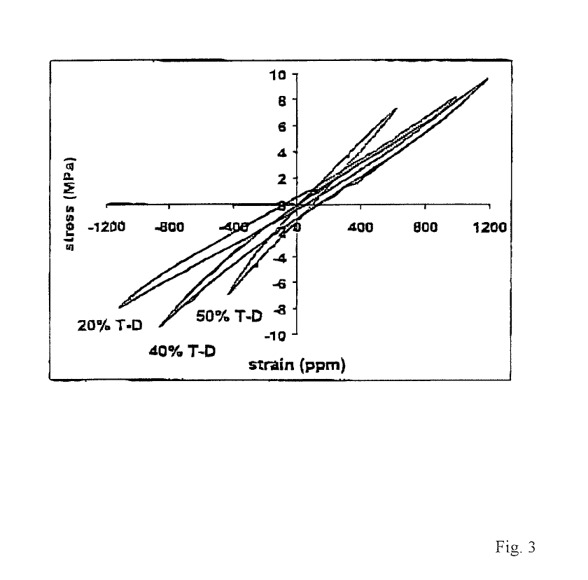

FIG. 3 gives sample results for stress-strain hysteresis loops for three composites tested in axial loading. The experimental data was then reduced using an analytical procedure typical for VEM's. A complex modulus model was fitted to the data and yielded both real and imaginary components of Young's modulus. These values were used to determine the energy absorption in the material. The complex modulus may be derived by assuming a phase lag between loading and displacement in a material commonly referred to as delta. The ratio of the imaginary to the real modulus is the tangent of this phase lag and is used to compare the relative damping performance of different materials.

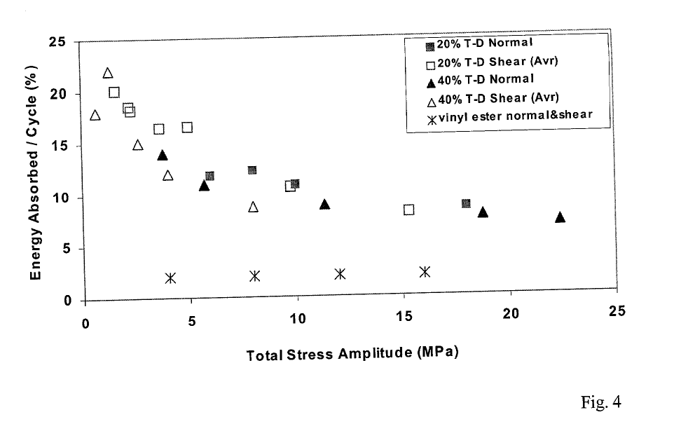

FIG. 4 presents an overall comparison of the materials tested in both axial and shear loading. The results have been graphed as a function of stress amplitude where for the shear loading the average stress though the cross section is used since it is not constant. The graphs illustrate the variation in damping property (tan delta) with stress amplitude. FIG. 4 shows that generally each of the materials with aligned particles exhibit high damping at low stress amplitudes and slowly decrease with increasing stress amplitudes. The damping property of the vinyl ester baseline material demonstrates that the contribution to damping by the Matrix Phase is small compared to the contribution of the Damping Phase in the composite specimens.

The particle volume fraction did not play a significant role in the magnitude of damping in each composite. The inventors believe that the Matrix Phase caused a load on the particles of the Damping Phase during curing, which is accompanied by a change of volume of the Matrix Phase. This pre-stressed state would reduce the magnitude of damping measured during the test. The pre-stressed state would be expected to be non-uniform as the percent volume of Damping Phase increased.

The maximum tan delta obtained was obtained at low stress amplitude torsion loading. We note that the torsion test allowed for a more accurate control of loading and thus the minimum strain amplitude cycle was reduced as compared to the axial loading. The authors believe that if a low stress amplitude axial test were performed, the result would be similar to those obtained in shear loading. The maximum magnitude of damping, while relatively high, is still well below the theoretical limit predicted by Hathaway [Hathaway, et al., supra]. Again, it is believed that this may be attributed to the residual stress state in the particles after fabrication and would be improved by changing the resin system used for the matrix material and by subsequent treatment to relieve residual stresses.

The decreasing trend of damping with increasing stress has been predicted by Hathaway, et al., and is due to the relatively low magnetic anisotropy of Terfenol-D at zero applied stress [Hathaway, et al., supra]. Higher magnetic anisotropy will shift the maximum damping properties to higher stress/strain amplitudes.

Conversely, by tailoring a pre-stressed state on the Damping Phase during processing, an “optimal” stress/strain amplitude can be selected. In each randomly oriented domain a critical applied stress reduces the energy barrier from one stable crystal orientation to another (domain wall motion). This jumping process is irreversible, absorbing a quantifiable amount of energy for each domain jumping process. After a domain has jumped, it behaves elastically until an opposite critical stress is applied, which can cause it to jump back to the original state, absorbing more energy. The energy absorbed by cycling between domain states results in damping of the vibrations in the material.

Results in FIG. 4 indicate that the damping produced by a specimen containing particles aligned perpendicular to the direction of loading was substantially smaller than when the particles were aligned with the loading direction. In fact, the damping property of the 20% perpendicular specimen was only slightly larger than the matrix material. This can be explained by approximating the particulate composite as a continuous fiber 1-3 composite with the load applied perpendicular to the fibers. Therefore, the stress (not the strain) in the particles is approximately equal to that of the matrix and the rest of the composite. This is in sharp contrast to the loading of a composite in the direction of the fiber where most of the load is supported by the fiber. For this later case, the stress in the particles is substantially higher than the overall composite stress, achieving the critical stress necessary for switching of domain states at lower applied loads on the composite as a whole. The amplified stress in the magnetostrictive material allows magnetization jumping to occur in a larger fraction of particles and thus more energy to be absorbed in the composite with particles aligned with the loading direction. The stress on the particulate Damping Phase with 20% by volume Damping Phase and applied stress perpendicular to the aligned composite was nearly less than the critical stress required to cause domain wall motion. This non-isotropic damping means that structures can be designed with directional damping properties proportional to the load level.

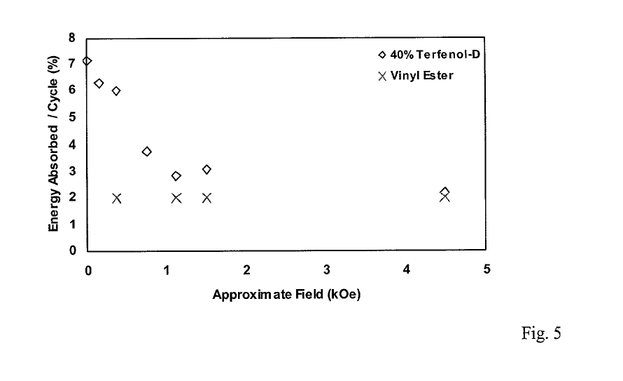

The effects of applying a constant magnetic field during cyclic loading was investigated using a solenoid mounted around the test setup. FIG. 5 presents the results of this test on a 40% volume fraction composite. The composite specimen was tested at constant stress amplitude of 8 MPa for all field strengths. Results reveal that the total magneto-elastic damping decreases as the applied field increases. At large magnetic field levels, the damping depends only on the polymer matrix component. The inventors believe that the applied field shifts the critical stress level to a higher value. This behavior can be used to produce a critical-stress-level-activated damping material, which would be useful, because damping would then be more efficient at higher loads.

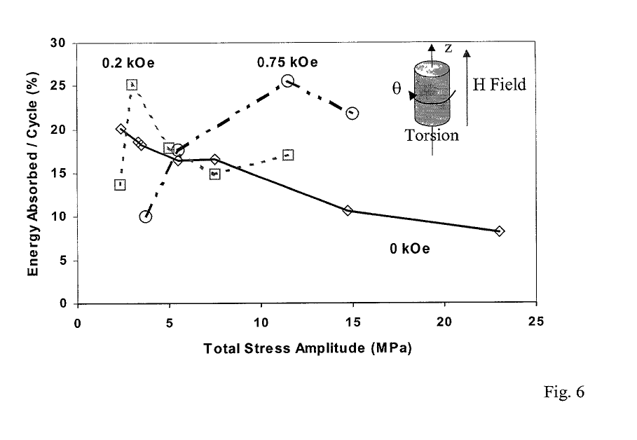

In a similar experiment, the energy absorption in shear loading while applying an static axial magnetic field was observed. The results are shown in FIG. 6. The energy absorbed for three separate magnetic fields magnitudes (0, 0.2, 0.75 kOe ) are plotted against total peak-to-peak stress amplitude for the 20% volume fraction composite. The stress-energy absorption is shifted out in stress space. That is, the peak value occurs at higher stress amplitudes with increasing magnetic field. This behavior can also be explained by considering the relationship between domain level processes and energy absorption. The mechanical energy necessary for magnetization jumping and domain wall motion is higher when an external magnetic field is added. Thus to increase the number of irreversible domain reorientations through magnetization jumping and other mechanisms, the amount of mechanical energy must be increased as the magnetic energy is increased. We believe that a peak also occurs in the zero field case (FIG. 6). However due to equipment limitations we are unable to accurately measure energy absorption in this low stress range.

Terfenol-D particulate polymer matrix composites present a combination of high energy absorption and high stiffness compared to other passively damping materials. The materials possess a peak tan delta of 0.25 at low stress amplitudes. Although this value is below the theoretical prediction for Terfenol-D, the inventors believe that the results are biased by initial residual stresses produced during processing of the composite samples used [Hathaway, et al., supra]. This theory is born out by the tests of the specimens at increasing stress amplitudes. The magnitude of damping in the materials decreases as the stress amplitude increases. This result was predicted theoretically by Hathaway et al. and is a result of the low magnetic anisotropy in Terfenol-D at zero applied stress and field [Hathaway, et al., supra]. Therefore, use of a Matrix Phase that does not prestress the Damping Phase, such as a matrix phase which does not shrink or expand during curing, or use of a processing step that relieves the stress caused by the curing step, such as a post-curing heat treatment, is suggested by the inventors to obtain a maximum magnitude of damping. Alternatively, the process can be engineered to provide a desired state of stress, which can further maximize the effectiveness of the Damping Phase.

In addition, the results showed that damping was a strong function of the material loading direction, which is a result of the anisotropic properties of the composites. This means that directionally selective dampers can be fabricated. Finally, the application of a constant bias magnetic field was found to decrease the magnitude of damping.

The following references are incorporated herein by reference: M. Brodt and R. S. Lakes, Journal of Composite Materials, 14:1823-1833 (1995); J. P. Teter, K. B. Hathaway, A. E. Clark, Journal of Applied Physics, Vol. 79 B: 6213-6215 (1996); K. B. Hathaway, A. E. Clark, J. P. Teter, Metallurgical and Materials Transactions A, Vol. 26A:2797-2801 (1995); L. Sandlund, M. Fahlander, T. Cedell, A. E. Clark, J. B. Restorff, M. Wun-Fogle, Journal of Applied Physics, Vol. 75: 5656-5658 (1994); T. A. Duenas and G. P. Carman, 1998 ASME, Anaheim, Calif., AD Vol. 57, MD 83: 63-73 (1998); and J. H. Goldie, M. J. Gerver, J. Olesky, G. P. Carman, T. A. Duenas, 1999 SPIE, Newport Beach, Calif., 3675: 23235 (1999).

Although the foregoing invention has been described in some detail by way of illustration and example for purposes of clarity and understanding, it will be obvious to one of ordinary skill in the art that various modifications and changes which are within the knowledge of those skilled in the art are considered to fall within the scope of the present invention.

What is claim is:

1. A composite material comprising:
a damping phase,
wherein the damping phase exhibits irreversible domain wall motion when acted on by a mechanical load exceeding a critical stress;
a matrix phase,
wherein the damping phase is dispersed within the matrix phase, and
wherein the damping phase is anisotropically aligned within the matrix phase, and
wherein the damping phase is less than about 60% by volume of the composite material, and
wherein the damping phase is greater than 0% by volume of the composite material.

2. The composite material of claim 1, wherein the damping phase comprises a piezoelectric material.

3. The composite material of claim 2, wherein the damping phase further comprises (Pb(ZrₓTi₍₁₋ₓ₎))O₃, wherein 0<x<1.

4. The composite material of claim 1, wherein the damping phase comprises an electrostrictive material.

5. The composite material of claim 4, wherein the damping phase further comprises [Pb(MgₓNb₍₁₋ₓ₎)O₃]_{(1-w)}—[PbTiO₃]_{w}, wherein 0<x<1 and 0<w<1

6. The composite material of claim 1, wherein the damping phase comprises a magnetostrictive material.

7. The composite material of claim 6, wherein the damping phase further comprises TbₓDy₍₁₋ₓ₎Fe_{(2-w)}, wherein 0.2≦x≦1.0 and 0≦w≦0.5.

8. The composite material of claim 6, wherein the damping phase further comprises SmₓFe_{(2-w)}, wherein 0.2≦x≦1.0 and 0≦w≦0.5.

9. The composite material of claim 6, wherein the damping phase is further comprised of particles.

10. The composite material of claim 1, wherein the damping phase is less than or equal to about 50% by volume of the composite material.

11. The composite material of claim 10, wherein the damping phase is greater than or equal to about 10% by volume of the composite material.

12. The composite material of claim 10, wherein the damping phase is about 20% by volume of the composite material.

13. The composite material of claim 10, wherein the damping phase comprises a magnetostrictive material.

14. The composite material of claim 13, wherein the damping phase further comprises TbₓDy₍₁₋ₓ₎Fe_{(2-w)}, wherein 0.2≦x≦1.0 and 0≦w≦0.5.

15. The composite material of claim 13, wherein the damping phase further comprises SmₓFe_{(2-w)}, wherein 0.2≦x≦1.0 and 0≦w≦0.5.

16. The composite material of claim 13, wherein the damping phase is further comprised of particles.

17. A process of fabricating a composite material, comprising mixing less than about 60% by volume damping phase into a matrix phase to form a mixture, wherein the damping phase exhibits irreversible domain wall motion when acted on by a mechanical load exceeding a critical stress;
forming the mixture into a desired shape;
applying an electromagnetic field, wherein the damping phase aligns within the matrix phase; and
solidifying the matrix phase while simultaneously applying the electromagnetic field.

18. The process of claim 17, wherein the damping phase is a particulate.

19. The process of claim 17, wherein the damping phase is elongated.

20. The process of claim 17, wherein the damping phase is a fiber.

21. The process of claim 17, wherein the step of forming into a desired shape further comprises:
sandwiching the mixture between a plurality of sheets of composite preform.
